(19) United States
(12) Patent Application Publication
(10) Pub. No.: US 2014/0278338 A1
(43) Pub. Date: Sep. 18, 2014

(54) STREAM INPUT REDUCTION THROUGH CAPTURE AND SIMULATION

(71) Applicant: INTERNATIONAL BUSINESS MACHINES CORPORATION, Armonk, NY (US)

(72) Inventors: James R. KOZLOSKI, New Fairfield, CT (US); Timothy LYNAR, Melbourne (AU); Kent STEER, Brunswick (AU); John WAGNER, North Melbourne (AU)

(73) Assignee: INTERNATIONAL BUSINESS MACHINES CORPORATION, Armonk, NY (US)

(21) Appl. No.: 14/030,389

(22) Filed: Sep. 18, 2013

Related U.S. Application Data
(63) Continuation of application No. 13/839,594, filed on Mar. 15, 2013.

(51) Int. Cl. G06F 11/34; G06F 17/50

(52) U.S. Cl. CPC G06F 11/3447; G06F 17/5009
USPC 703/22

(57) ABSTRACT

An information processing system and a computer readable storage medium, for regulating input data streams of a stream computing environment. A processor of the information processing system captures one or more data streams history of inputs and outputs of a working stream computing environment (SCE). The processor off-line simulates at least one candidate training model of the SCE processing input data streams and output data streams according to the one or more data streams history. The processor varies modulation of the input data streams into the candidate training model during the off-line simulation, analyzes effects of the varying modulation of input data streams on the off-line simulation of the SCE, determines, based on the analyzing, effectiveness of each of the at least one candidate training model of the SCE to regulate input data streams without affecting, within acceptable tolerance limits, the SCE processing of the output data streams.

### CROSS-REFERENCE TO RELATED APPLICATIONS

This application is based upon and claims priority from prior U.S. patent application Ser. No. 13/839,594, filed on Mar. 15, 2013, now U.S. Pat. No. ______, the entire disclosure of which is herein incorporated by reference in its entirety.

### BACKGROUND

The present disclosure generally relates to stream computing environments, and more particularly relates to an information processing system that regulates data input streams for a streams computing environment.

Stream computing is a computing paradigm where data is processed as it is received. This paradigm arose from necessity as more data is now being generated than can be stored or processed. One of the challenges of stream computing is that there is often more data being received than can be processed, transmitted, or utilized. In many instances the number of data streams being received is greater than required.

Within stream computing, certain limited techniques of down-sampling and compression have been used inside a stream computing system to alleviate the burden on internal processing and on the transmission of data. However, these techniques have not been implemented in a dynamic manner that takes into account the whole system. These techniques cannot be used to identify strategies to optimally control the frequency of data from individual, as well as multiple, input data streams.

Unfortunately, conventional stream computing environments have not kept up with this increasing amount of streaming data from multiple input data streams and at times can be overwhelmed by too much data.

### BRIEF SUMMARY

In one embodiment, a method for regulating input data streams of a stream computing environment is disclosed. The method includes capturing one or more data streams history of at least inputs and outputs of a working stream computing environment (SCE); off-line simulating, with a processor of an information processing system, at least one candidate training model of the SCE processing input data streams and output data streams according to the one or more data streams history; varying modulation of the input data streams into the at least one candidate training model of the SCE during the off-line simulation; analyzing effects of the varying modulation of the input data streams on the off-line simulation of the SCE processing of the output data streams; and determining, based on the analyzing, effectiveness of each of the at least one candidate training model of the SCE to regulate input data streams without affecting, within acceptable tolerance limits, the off-line simulation of the SCE processing of the output data streams.

In another embodiment, an information processing system includes memory; a stream history repository for storing one or more data stream history collected from at least inputs and outputs of a working stream computing environment (SCE); a training model repository for storing at least one candidate training model of the SCE processing input data streams and output data streams; an SCE simulator for off-line simulating the SCE according to at least one of the candidate training model of the SCE processing input data streams and output data streams based on one or more data streams history stored in the stream history repository; an SCE I/O Analyzer for analyzing a simulation of the SCE processing input data streams and output data streams based on one or more data streams history stored in the stream history repository; and a processor communicatively coupled to the memory, the stream history repository, the training model repository, the SCE simulator, and the SCE I/O Analyzer, wherein the processor, responsive to executing computer instructions, performs operations comprising: capturing one or more data streams history of at least inputs and outputs of a working stream computing environment (SCE); off-line simulating, with the processor, at least one candidate training model of the SCE processing input data streams and output data streams according to the one or more data streams history; varying modulation of the input data streams into the at least one candidate training model of the SCE during the off-line simulation; analyzing effects of the varying modulation of the input data streams on the off-line simulation of the SCE processing of the output data streams; and determining, based on the analyzing, effectiveness of each of the at least one candidate training model of the SCE to regulate input data streams without affecting, within acceptable tolerance limits, the off-line simulation of the SCE processing of the output data streams.

In yet another embodiment, a computer readable storage medium, includes computer instructions which, responsive to being executed by a processor, cause the processor to perform operations comprising: capturing one or more data streams history of at least inputs and outputs of a working stream computing environment (SCE); off-line simulating, with a processor of an information processing system, at least one candidate training model of the SCE processing input data streams and output data streams according to the one or more data streams history; varying modulation of the input data streams into the at least one candidate training model of the SCE during the off-line simulation; analyzing effects of the varying modulation of the input data streams on the off-line simulation of the SCE processing of the output data streams; and determining, based on the analyzing, effectiveness of each of the at least one candidate training model of the SCE to regulate input data streams without affecting, within acceptable tolerance limits, the off-line simulation of the SCE processing of the output data streams.

### BRIEF DESCRIPTION OF THE DRAWINGS

The accompanying figures, in which like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating a first example of data streams controller communicatively coupled with a stream computing environment, according to various embodiments of the present disclosure;

FIG. 2 is a block diagram illustrating a second example of data streams controller communicatively coupled with a stream computing environment, according to various embodiments of the present disclosure;

FIG. 3 is a block diagram illustrating a third example of data streams controller communicatively coupled with a stream computing environment, according to various embodiments of the present disclosure;

FIG. 4 is a block diagram illustrating a fourth example of data streams controller communicatively coupled with a stream computing environment, according to various embodiments of the present disclosure;

FIGS. 5A and 5B constitute a block diagram illustrating an example operating environment for a data stream controller comprising an information processing system that is communicatively coupled with a stream computing environment, according to various embodiments of the present invention;

FIG. 6 is an example of data streams history stored in the stream history repository shown in FIG. 5B;

FIG. 7 is an operational flow diagram illustrating a first example process followed by a processor of the information processing system shown in FIG. 5B, according to one embodiment of the present disclosure;

FIG. 8 is an operational flow diagram illustrating a second example process followed by the processor of the information processing system shown in FIG. 5B, according to one embodiment of the present disclosure; and

FIG. 9 is an operational flow diagram illustrating a third example process followed by the processor of the information processing system shown in FIG. 5B, according to one embodiment of the present disclosure.

### DETAILED DESCRIPTION

This disclosure, according to various embodiments of the invention, provides a system and method for regulating the streaming data inputs to a stream computing environment (SCE) while maintaining the SCE's ability to produce the same outputs or information within a specified tolerance. An embodiment of the invention, for example, off-line simulates the SCE using stored data streams sampled from the actual working SCE to identify candidate data input streams for regulation in a context-sensitive manner. These data input streams can be regulated (controlled) by a data stream controller either in a binary fashion (off or on) or in a graded (modulated) manner. Input data streams are selected for control through exhaustive search through stored samples of data streams or by other analysis of the stored data streams (e.g., by using heuristics related to the stored data streams). An important aspect of the analysis is that the reduction in input data does not affect the actual working SCE's ability to produce the same outputs or information from the remaining input data streams.

Various embodiments of the invention can provide, based on regulating input data streams of the working SCE, one or more of the following: reduced computational load of the SCE, reduced or controlled energy usage of the SCE, reduced bandwidth usage and/or bandwidth requirements between data input stream sources and the SCE (reduce bandwidth requirements of one or more channels that communicate the regulated input data streams to the working SCE), and reduced data storage requirements of the SCE. For example, in a fire detection system, when a number of sensors in a geographic area indicate high temperatures and low humidity and winds are prevailing from the west, it may be determined that the incoming data streams from rain sensors in that area could be selectively down-sampled (i.e., sampled at a lower rate) or selectively eliminated altogether from the input data streams. As another example, a number of sensors are deployed in a field to sense a particular event. Say, a system is sensing precipitation with these sensors, or maybe sensing only soil moisture. One embodiment of the present invention would optimally work out how many of these sensors are needed to use at any one point in time to reduce the amount of data that the system is processing and transmitting, while not losing any important information needed by the system to arrive at a desired result.

Various embodiments of the invention can examine information content (e.g., from input data streams, from output data streams, and from contextual input streams), while, on the other hand, conventional systems in the past have merely superficially inspected overall data message packets flowing in data streams. While an embodiment of the invention can operate externally and non-invasively regulating input data streams to a pre-existing SCE, alternative embodiments can be added to an existing SCE. Various embodiments can control energy usage of the SCE, reduce computational load on the SCE, reduce bandwidth and/or bandwidth requirements of data stream communications with the SCE, and reduce data storage requirements associated with the SCE.

FIG. 1 shows one example of an operating environment 100 for a Data Stream Controller 108 comprising an information processing system, which is applicable to various embodiments of the present disclosure. With reference to FIG. 1, a Stream Computing Environment (SCE) 102 passes a set of input data streams 104 through a series of processes to produce a set of outputs (which may include one or more output data streams) 106. The Data Stream Controller (DSC) 108, according to one example implementation, periodically samples the input data streams 104 with first sampler circuits 105 and also samples the outputs 106 with second sampler circuits 107, as shown. These samples of the input and output data streams of the SCE 102, according to the present example, may be stored by the DSC 108 for later processing, or processed immediately following sampling. The DSC 108 may receive additional contextual inputs 110 which characterize the contextual environment in which the SCE 102 operates.

The DSC 108 employs at least one of the methods and processes described below to regulate the input data streams 104 by controlling input stream regulators 120, 122, via control circuits 123. Historical samples of the input data streams 104, the output data streams 106, and the contextual data streams 110, may or may not be stored within the DSC 108 as part of this monitoring and control process, as will be discussed in more detail below.

According to various embodiments, the DSC 108 determines the impact of changes to the SCE 108 input data streams 104 on the SCE 102 output data streams 106, such as by looking at the sensitivity of the SCE 102 output data streams 106 with respect to the input data streams 104. Any one or more input data streams with little or no influence on the output data streams 106 can be removed/down-sampled and those with greater influence can optionally, where appropriate, be up-sampled. Determining this impact can be accomplished in a number of various ways.

For example, the DSC 108 can employ an actual replica or an approximate model of the SCE 102 to evaluate candidate modulation schemes (candidate SCE Training Models). In such a case, the solution space, which would be the complete set of candidate modulation schemes, could be searched by the DSC 108 using an optimization algorithm or completely enumerated. In the case of an exhaustive completely enumerated search, typically this would involve typically searching through a sufficiently small set of candidate modulation schemes. An exhaustive search of all the combinations of inputs to be potentially ignored requires 2̂n simulations per SCE training model.

Alternatively, the DSC 108 could attempt to model the input-output relationship defined by the SCE 102 into a SCE training model. For example, in this “black box” approach the DSC 108 would use correlation model or a machine learning approach to determine which inputs 104 and outputs 106 are important to the SCE 102, or how important the inputs 104 and the outputs 106 may be. This approach can be viewed as a mapping from a vector containing inputs, outputs, and context, onto the solution space.

In all cases of evaluating SCE models, the contextual inputs 110 can be used in modeling the SCE 102 to determine which one or more inputs 104 and which one or more outputs 106 have important data streams for the SCE 102. For example, contextual inputs 110 may be used to select a subset of SCE output data streams 106 whose accuracy should be preserved.

Note that in all cases where an optimization algorithm approach is utilized numerous evaluation (or objective) functions can be constructed. It may be desirable to reduce, and preferably minimize, bandwidth usage at the one or more inputs of the SCE 102 receiving the input data streams 104, without producing an error in the outputs 106 greater than some threshold (or tolerance). This error would be a measure of the difference between the output of the replicate (candidate SCE Training Model) when exposed to the sampled input data streams 104 under the candidate modulation schemes and the sampled outputs 106 of the SCE 102 with the original, un-modulated inputs 104. It may be desirable to minimize the aforementioned error subject to some constraint on the bandwidth or the energy consumption of the SCE 102. Further, it may be desirable to minimize energy consumption subject to constraints on bandwidth and error. Furthermore, where the context of the SCE 102 while utilizing inputs 104 to produce outputs 106 is considered by the DSC 108, it can be used to select between candidate SCE models in order to reflect the changing priorities of such context.

According to various embodiments of the present invention, the DSC 108 can control (via the control circuits 123), the input data stream regulators 120, 122, according to a binary stream input modulator scheme (or model). One or more of the input data streams 104 can be switched on or off to produce a discreet and finite solution space for modulation of input data streams 104 for the SCE 102. Alternatively, according to various embodiments, one or more of the input data streams 104 can be down-sampled or up-sampled such that the data rate over that particular one or more input data streams 104 is decreased on increased, respectively. The resultant solution space may be discreet, continuous, or mixed, and would typically be bounded.

The time period of sample collection by the DSC 108, according to various embodiments, is selected based on processing, storage, and analysis requirements for the DSC 108.

According to one example, streams are first identified as candidates for sampling and then are captured and stored in a data stream history based on analysis of data transfer trends (for example, if a system is nearing its capacity to process incoming streams, and has exceeded some threshold, it may store certain samples for future analysis, or based on a predetermined interval (for example, during peak periods of the day, the system may sample snippets at a regular period, such that during off-peak hours, an analysis using the process described herein may occur).

These samples of data streams are then used to off-line simulate the stream computing environment over some window of time. The simulation may occur when there is available processing capacity, and general activity has fallen below a threshold. The simulation step spawns many instances of an analytics pipeline, uses stored samples of incoming data streams minus one or many inputs (for each instance), and records the output. The instances may be cloud based, grid based, distributed, or local. If the output is the same as that produced in each of the historical examples then this setting is marked as a candidate for selective online elimination, given the context for this stream's elimination is similar. Note: while the input may be data, the output could be information, e.g., the input could be weather data and the output a string indicating the weather conditions at a point in time in the future i.e. “mostly sunny”.

While the embodiment illustrated in FIG. 1 has access to the input data streams 104 and output data streams 106 and can control the regulators 120, 122, without data transmission limitations, alternative overall system arrangements that include some level of data transmission limitations related to the control of the regulators 120, 122, are also anticipated by the present disclosure. For example, as shown in FIG. 2, data transmission is limited with respect to the input data stream regulators (or also referred to as modulators) 120, 122. As shown in FIG. 2, the input data stream modulators 120, 122 transmit their respective data streams to receivers 204, 206 that are communicatively coupled without data transmission limitations to the inputs of the SCE 102. The regulators 120, 122 are controlled by the DSC 108 via respective transmission limited data communication channels 202.

As illustrated in FIG. 2, the input data streams 104 are sampled by the DSC 108 via data communication channels 105 that are not data transmission limited, and similarly the output data streams 106 are sampled by the DSC 108 via data communication channels 107 that are not data transmission limited. Similarly, the data receivers 204, 206, are controlled by the DSC 108 via communication channels 207 that are not data transmission limited. However, it should be noted that the input data streams regulators 120, 122 are communicatively coupled with the respective receivers 204, 206 via data transmission limited channels 203.

Referring to FIG. 3, an overall operating environment for the DSC 108 is illustrated with remote communication with respect to the SCE 102. However, in this example, the input data streams regulators 120, 122, are controlled by the DSC 108 via communication channels 123 that are not data transmission limited. The data input streams 104 are sampled by the DSC 108 via communication channels 301 that are data transmission limited, and the output data streams are sampled by the DSC 108 via communication channels 303 that are data transmission limited. Similar to the embodiment discussed with respect to FIG. 2, the input data stream regulators 124, 122 are communicatively coupled with the data streams receivers 302, 304 via communication channels 305 that are data transmission limited.

Referring to FIG. 4, an overall operating environment for the DSC 108 that is generally data transmissions limited is shown. In this example, the communication channels 401 used by the DSC 108 to control the data streams regulators 120, 122 are data transmission limited. The remaining overall system components shown in FIG. 4 have already been discussed with respect to FIG. 3.

Referring to FIGS. 5A and 5B, an overall operating environment 500 for a DSC comprising an information processing system 502 that is communicatively coupled to a remotely located SCE 504 via data transmission limited channels is shown. The overall arrangement of the operating environment 500 with remotely located SCE 504 and data transmission limited communication channels is similar to the example discussed with respect to FIG. 4.

The SCE 504 is communicatively coupled with the data stream controller information processing system 502 via one or more communication networks 506 as shown. Input data streams 508 are communicatively coupled to the SCE 504 via respective regulators 510, receivers 512, and samplers 514 that sample the input data streams 508 at the inputs of the SCE 504. These sampler circuits 514 are remotely controllable by the information processing system 502 via communication channels 516 as shown. The output data streams 518 from the SCE 504 are sampled by respective sampling circuits 520 that are communicatively coupled remotely with the information processing system 502 via a communication channel 521 as shown. The regulators 510 are remotely controllable by the information processing system 502 via the communication networks 506 as shown. In this way, similar to the discussion with reference to FIG. 4, the data stream controller information processing system 502 can monitor data streams 508, 518, and other related information pertaining to the SCE 504 and can regulate the input data streams 508 with the regulators 510.

With particular reference to FIG. 5B, the information processing system 502 comprises at least one processor/controller 530 that is communicatively coupled with one or more interface modules 531 that allow the information processing system 502 to communicate with other systems and devices. For example, the interface modules 531 can be communicatively coupled with the networks 506 such that the information processing system 502 can communicate with the various components of the operating environment 500 as shown and as will be discussed in more detail below.

The processor/controller 530 is communicatively coupled with memory 532 and with non-volatile memory 534 as shown. The non-volatile memory 534 can include storage of programs, data, and configuration parameters for the information processing system 502. A user interface 536 is communicatively coupled with the processor/controller 530 such that a user of the information processing system 502 can provide user input via a user input interface 540 and can receive output from the information processing system 502 via a user output interface 538.

The user output interface 538 may include one or more display devices to display information to a user of the system 502. A display device (not shown) can include a monochrome or color Liquid Crystal Display (LCD), Organic Light Emitting Diode (OLED) or other suitable display technology for conveying images to a user of the information processing system 502. A display device can include, according to certain embodiments, touch screen technology, e.g., a touchscreen display, which also serves as a user input interface 540 for detecting user input (e.g., touch of a user's finger). A display device, according to certain embodiments, comprises a graphical user interface (GUI). One or more speakers in the user output interface 538 can provide audible information to the user, and one or more indicators can provide indication of certain conditions of the system 502 to the user. The indicators can be visible, audible, or tactile, thereby providing necessary indication information to the user of the information processing system 502.

The user input interface 540 may include one or more keyboards, keypads, mouse input device, track pad, and other similar user input devices. A microphone is included in the user input interface 540, according to various embodiments, as an audio input device that can receive audible signals from a user. The audible signals can be digitized and processed by audio processing circuits and coupled to the processor/controller 502 for voice recognition applications such as for the information processing system 502 to receive data and commands as user input from a user.

The processor/controller 530 is communicatively coupled with a stream history repository 542. The stream history repository 542 can be used to store data streams history information and related data as will be discussed below.

The processor/controller 530 is communicatively coupled with a training model repository 544. The training model repository 544 can be used to store one or more candidate training models for evaluating the particular training models to determine a best training model to use as a working model that would be stored in the working model repository 546. The working model stored in the working model repository 546, which is communicatively coupled with the processor/controller 530, can be used by processor/controller 530 to control and regulate input data streams 508 that are communicatively coupled with the SCE 504, as will be discussed in more detail below.

A data streams sample controller 548 interoperates with the processor/controller 530 to collect samples of data streams from the first set of samplers 514 that are sampling the inputs to the SCE 504 and the second set of samplers 520 that are communicatively coupled with the outputs 518 of the SCE 504. A history builder 550 interoperates with the processor/controller 530 to build a data streams history of the collected (captured) samples of data streams in the stream history repository 542. The data streams history stored in the stream history repository 542 can include an organized collection of these samples of data streams and other related information that can be used by the information processing system 502 to evaluate one or more SCE training models stored in the training model repository 544. A non-limiting example of data streams history stored in the stream history repository 542 is illustrated in FIG. 6.

According to the present example, without limitation, a plurality of samples 602, 604, 606, 608, 610 are stored in the collection of data streams history stored in the stream history repository 542 as shown in FIG. 6. Each sample can include various types of data. For example, the sampled one or more input data streams can be stored as indicated by the column labeled I 612. In similar fashion, the sampled one or more output data streams can be stored in each sample as indicated by the column labeled O 614. Sampled one or more contextual inputs can be stored in each sample as indicated by the column labeled C 616. A sample time stamp 618 is included in each sample, according to the present example. Information about the SCE State 620 corresponding to a particular sample (e.g., for a particular time interval) can be included in each sample as shown. Other related information 630 can be included in each sample as well.

Returning to the discussion with reference to FIGS. 5A and 5B, the SCE Simulator 554 can operate according to one or more SCE training models stored in the training model repository 544 to off-line simulate the SCE 504 under various contexts and instances of regulation of input data streams 508 coupled with the SCE 504. The data stream history stored in the stream history repository 542 can be used by the SCE simulator 554 and analyzed by the SCE I/O analyzer 552 to evaluate the effectiveness of the particular SCE training model stored in the training model repository 544 to regulate input data streams without affecting, within acceptable tolerance limits, the off-line simulation of the SCE processing of the output data streams.

After analyzing and categorizing the one or more SCE training models that are candidate solutions for regulating the input data streams 508 into the SCE 504 under a particular context of operation of the SCE 504, the SCE I/O Analyzer 552 selects one of the candidate SCE training models as the best candidate SCE training model for regulating the input data streams 508 into the SCE 504 under a particular context. This selected SCE training model would be transferred by the processor/controller 530 into the working model repository 546. The selected working model in the working model repository 546 is used by the information processing system 502 to regulate the input data streams 508 using the regulators 510, based at least on the selected SCE model. More specifically, the input stream regulator controller 556 interoperating with the processor/controller 530 uses the SCE working model in the working model repository 546 to control the regulators 510 and thereby the input data streams 508 entering inputs of the SCE 504.

According to various embodiments, while an SCE working model is used by the information processing system 502 to regulate the input data streams 508 flowing into the SCE 504, a signal processing monitor 557 interoperates with the processor/controller 530 to monitor the content of the input data streams 508, the content of the output data streams 518, and the contextual input data streams that provide additional contextual information about the operations of the SCE 504. While not shown explicitly in FIGS. 5A and 5B, these contextual input data streams are received by the information processing system 502 via the networks 506 from other systems and devices, some of which are communicatively coupled with the SCE 504. For example, a monitor of the states of the SCE 504 under various operating conditions can relay captured SCE state information via the network 506 to the information processing system 502 to provide SCE state information. This SCE state information can be collected by the information processing system 502 as part of operation of an SCE working model in the working model repository 546. A collected set of samples of data streams is stored by the history builder 550 in the stream history repository 542. An example of SCE state information 620 stored in the stream history repository 542 is illustrated in FIG. 6 and has been discussed above with reference to FIG. 6.

Lastly, the processor/controller 530 via the interface module(s) 531 is communicatively coupled with a media reader/writer 560. The media reader/writer 560 can interoperate with the processor/controller 530 to read and write machine (computer) readable media 562 that may be communicatively coupled with the media reader/writer 560. Machine readable media 562, which are a form of computer readable storage medium, may be coupled with the media reader/writer 560 to provide information via the input/output interface module 531 to-from the processor/controller 530 of the information processing system 502. For example, data and program instructions for the processor/controller 530 may be provided via the machine readable media 562 and stored in the memory 532 or in the nonvolatile memory 534.

Referring now to FIGS. 7 to 9, these flow diagrams illustrate the architecture, functionality, and operations of possible implementations of systems, methods, and computer program products according to various embodiments herein. In this regard, each block in the flow diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently (or contemporaneously), or the blocks may sometimes be executed in the reverse order, depending upon the functionality involved. It will also be noted that each block of a flow diagram illustration, and combinations of blocks in the flow diagram, can be implemented by special purpose hardware-based systems that perform the specified functions or acts, or combinations of special purpose hardware and computer instructions.

Referring now specifically to FIG. 7, according to the present example, the processor/controller 530 enters, at step 702, the operational sequence and proceeds, at step 704, to monitor stream inputs, stream outputs, and stream computing work load. The collected samples and related information are stored, by the processor/controller 530, in the stream history repository 542. The processor/controller 530, at step 706, analyzes stored stream I/O history based on off-line simulation of an SCE training model. The results of this analysis are stored and associated with a particular instance of an SCE training model stored in the training model repository 544. Each instance being analyzed changes the composition of input streams that are being communicatively coupled to the SCE 504 according to the particular SCE training model. A change in the composition of input streams can include, but is not limited to, a change in the number of inputs, a change in the combination of inputs, or both.

While there are more SCE training models to analyze, at step 708, the processor/controller 530 continues to analyze and capture results, at step 706. Thereafter, at step 710, the processor/controller 530 compares the results of each instance of SCE training model to a base set of results for a full set of inputs being communicatively coupled with the SCE 504 according to such an SCE training model. The processor/controller 530, at step 712, determines whether results of an instance of SCE training model being analyzed are the same, or nearly the same based on a defined threshold, to results of a full set of data stream inputs to the SCE 504 according to the particular SCE training model. If so, the processor/controller 530 flags that instance as a candidate for removal of the inputs that were removed from the input data streams 508 according to the particular instance. After all the instances have been evaluated as potential candidates for removal of one or more inputs from the input data streams 508, the processor/controller 530 exits the operational sequence, at step 714. Thereafter, according to the present example, the processor/controller 530 can select any one of the candidate SCE training models to apply the selected candidate SCE training model as a working SCE model (a working solution) to regulate the input data streams (e.g., a binary turning on or off of certain input data streams) for the SCE, such as to meets certain system operational criteria and priorities for the SCE. More details of an example of a selection process will be discussed below.

Referring to FIG. 8, the processor/controller 530 enters the operational sequence, at step 802, and proceeds at step 804, to monitor and collect samples of stream inputs, stream outputs, contextual inputs, and SCE work load related information. The collected samples and related information are stored as one or more SCE I/O history (e.g., one or more collections) in the stream history repository 542. The processor/controller 530, at step 806, identifies SCE training models that are candidate solutions for regulating the input data streams 508 of the SCE 504 under a particular context. These SCE training models are identified based on exhaustive searching and testing using one or more history (e.g., one or more collections) stored in the stream history repository 542 applied to the candidate training model stored in the training model repository 544, or using other heuristics approach. For example, see the discussion above with reference to FIG. 7.

According to the present example, the processor/controller 530 will now attempt to select one of the SCE training models that are candidate solutions as the best candidate solution to apply as a working model to the SCE 504. The processor/controller 530, at step 808, tests each of the SCE training models that are candidate solutions against data streams stored as history in the stream history repository 542. These tests yield results for each of the SCE training models. The results are scored by the processor/controller 530 according to various criteria and priorities for the SCE 504, that include, but are not limited to, meeting a goal of not affecting, or significantly affecting, the output data streams 518 of the SCE 504, as well as other priorities specified with respect to the scoring criteria. The processor/controller 530 then ranks these scores to identify and select, at step 810, the highest ranked SCE training model as the best candidate solution. That is, each SCE training model is ranked based on a score assigned to each candidate, at least based on the effectiveness of the each candidate to regulate input data streams without affecting, within acceptable tolerance limits, the off-line simulation of the SCE processing of the output data streams. For example, the results could be ranked based on the distance of the result from the original system operation, and the potential data transferring and processing savings provided by each solution.

According to various embodiments, the score assigned to the each candidate training model comprises a weighted sum score (WS) calculated for the each candidate, based on the off-line simulation of the SCE. The formula WS=w1*S+w2*R, is an example that can be used for this calculation, where
S=a merit score indicative of the effectiveness to regulate input data streams without affecting, within acceptable tolerance limits, the SCE processing of the output data streams, and
R=a merit score indicative of a reduction (or savings) in at least one, or a combination, of the following:
   reduction in bandwidth usage at one or more inputs of the SCE that received the regulated input data streams, reduction in bandwidth requirements of one or more channels that communicate the regulated input data streams to the SCE, reduction in data storage requirements of the SCE, reduction in computational load of the SCE, and reduction in energy usage of the SCE. Further, each of the weight values (w1 and w2) is within a range that indicates the relative importance to the SCE under a particular context of operation of the SCE.

This best candidate solution is then stored in the working model repository 546 as a working model for the SCE 504. The processor/controller 530 then exits the operational sequence, at step 814.

Referring to FIG. 9, the processor/controller 530 enters the operational sequence, at step 902. Then at step 904, the processor/controller 530 identifies ranges of values of input data streams that were applied from the SCE data streams history stored in the stream history repository 542 to candidate solution SCE training models. The identified ranges of values of various input data stream are set as a set of tolerance limits for the SCE working model. This SCE working model is stored in the working model repository 546.

The processor/controller 530, at step 906, interoperates with the signal processing monitor 557 to monitor the signals (i.e., the content and values of the data flowing in the data streams) as processed by the SCE 504 while in the context for being regulated by the Input Stream Regulator Controller 556 using the SCE working model. The content and values of the input data streams 508 and the output data streams 518 can be monitored with the signal processing monitor 557. These data streams are sampled by the information processing system 502 from the inputs and outputs of the SCE 504 as has been discussed above, and then stored as data streams history in the stream history repository 542. The signal processing monitor 557 can process and analyze the content and values of the input data streams 508 and the output data streams 518 either right away after sample collection or at a later time. The processor/controller 530 interoperates with the signal processing monitor 557 to determine whether the SCE data streams have values that remain within certain specified tolerance limits. The processor/controller 530, at step 908, determines whether the data streams's data values remain within tolerance limits specified for the SCE working model. If data values remain within tolerance limits, at step 908, the processor/controller 530 exits the operational sequence, at step 910.

However, if the processor/controller 530, at step 908, determines that the streams's data values are not within the tolerance limits then, at step 912, the processor/controller 530 attempts to select a next highest ranked SCE training model, if available, to replace the current SCE working model for the particular context of operation. That is, the next highest ranked SCE training model would have tolerance limits that are compatible with the currently sampled and monitored tolerance limits for the data values of the data streams in the particular context.

If another SCE training model is available, at step 912, then the processor/controller 530, at step 914, switches the current SCE working model with the next highest ranked available SCE training model, and then exits the operational sequence, at step 918. On the other hand, if no other candidate SCE training model is available, at step 912, then the processor/controller 530, at step 916, restores the SCE 504 to receiving all input data streams 508 with no SCE working model to regulate the input data streams 508 that are communicatively coupled with the SCE 504. The processor/controller 530 then exits the operational sequence, at step 918.

### SUMMARY OF NOVEL ASPECTS OF VARIOUS EMBODIMENTS OF THE INVENTION

1. An inventive method may include certain machine learning approaches which can be used by a system to associate input streams with a particular context under which they may be used, and may take as additional inputs non-stream data. This approach could be used to control bandwidth.

2. An inventive method may allow data streams (in a particular context of operation of the SCE) to be automatically analyzed and categorized as required, candidates for selective down-sampling, or candidates for selective elimination (i.e., ignored) from data stream processing.

3. An inventive method may include identification of usable sets of sampled data streams, which may be overlapping or mutually exclusive for each identified context. The traversal of usable sets to re-evaluate a processing scheme (e.g., re-evaluate a working SCE model) and/or to select a new scheme (e.g., select a candidate SCE model that replaces the current working SCE model) is a new and novel process.

4. An inventive method may be implemented entirely in hardware, using FPGA's, GPUs, or other high performance stream processing tools.

5. An inventive method may include active learning, which would allow a system to automatically establish confidence in a stream reduction scheme to an acceptable level for a given stream computing context. Active learning would then revert to a user query or administrator control, and suggest predefined sets for that situation. User/administrator input would then be recorded and used in future encounters with the same context.

6. Simulations, according to various embodiments, may be run in parallel, and allow for direct dynamic reduction of the data streams (thus requiring no storage for analysis).

7. An inventive method may be federated, such that several machine learning techniques and/or analysis methods may contribute to a final decision for a stream reduction approach. This decision may, for example, be performed by an automated method “voting” scheme.

8. An inventive method may be used alternatively in a context dependent manner and in a non-context dependent manner. Context may be incorporated when a burden of context analysis is below a predefined limit, and the potential benefit of context analysis is determined to be high.

9. An inventive method may be used when bandwidth is fixed, and only some streams can be computed in parallel. Streams and their corresponding sample rates are then selected to maximize accuracy within given fixed bandwidth constraints.

As will be appreciated by one of ordinary skill in the art, aspects of the various examples may be embodied as a system, method, or computer program product. Accordingly, examples herein may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, aspects herein may take the form of a computer program product embodied in one or more computer readable media having computer readable program code embodied thereon.

Any combination of one or more computer readable media may be utilized. A computer readable medium may be a computer readable signal medium or alternatively a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electrical, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including streams programming language such as IBM's Streams Processing Language, object oriented languages such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer, and partly on a remote computer or entirely on the remote computer. The remote computer, according to various embodiments, may comprise one or more servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to various embodiments of the disclosure. It will be understood that one or more blocks of the flowchart illustrations and/or block diagrams, and combinations of blocks in the flowchart illustrations and/or block diagrams, can be implemented by computer program instructions. These computer program instructions may be provided to one or more processors, to a special purpose computer, or to other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner. Instructions stored in a computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In accordance with various embodiments, the methods described herein are intended for operation as software programs running on a computer processor. Furthermore, software implementations can include, but are not limited to, distributed processing or component/object distributed processing, parallel processing, or virtual machine processing and can also be constructed to implement the methods described herein.

While the computer readable storage medium 562 is shown in an example embodiment to be a single medium, the term “computer readable storage medium” should be taken to include a single medium or multiple media (e.g., a centralized or distributed database, and/or associated caches and servers) that store the one or more sets of instructions. The term “computer-readable storage medium” shall also be taken to include any non-transitory medium that is capable of storing or encoding a set of instructions for execution by the machine and that cause the machine to perform any one or more of the methods of the subject disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a computer-readable storage medium, as listed herein and including art-recognized equivalents and successor media, in which the software implementations herein are stored.

Although the present specification may describe components and functions implemented in the embodiments with reference to particular standards and protocols, the disclosure is not limited to such standards and protocols. Each of the standards represent examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Although only one processor 530 is illustrated for information processing system 502, information processing systems with multiple CPUs or processors can be used equally effectively. Various embodiments of the present disclosure can further incorporate interfaces that each includes separate, fully programmed microprocessors that are used to off-load processing from the processor 530. An operating system (not shown) included in main memory for the information processing system 502 is a suitable multitasking and/or multiprocessing operating system, such as, but not limited to, any of the Linux, UNIX, Windows, and Windows Server based operating systems. Various embodiments of the present disclosure are able to use any other suitable operating system. Some embodiments of the present disclosure utilize architectures, such as an object oriented framework mechanism, that allows instructions of the components of operating system (not shown) to be executed on any processor located within the information processing system. The input/output interface module(s) 531 can be used to provide an interface to at least one network 506. Various embodiments of the present disclosure are able to be adapted to work with any data communications connections including present day analog and/or digital techniques or via a future networking mechanism.

Although the illustrative embodiments of the present disclosure are described in the context of a fully functional computer system, those of ordinary skill in the art will appreciate that various embodiments are capable of being distributed as a computer program product via CD or DVD, e.g. CD, CD ROM, or other form of recordable media, or via any type of electronic transmission mechanism.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The term “communicatively coupled” or “communicatively coupling” includes, but is not limited to, communicating electronic control signals by which one element may direct or control another. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. Any suitably configured processing system is similarly able to be used by embodiments herein, for example and not for limitation, a personal computer, a laptop computer, a tablet computer, a smart phone, a personal digital assistant, a workstation, or the like. A processing system may include one or more processing systems or processors. A processing system can be realized in a centralized fashion in one processing system or in a distributed fashion where different elements are spread across several interconnected processing systems.

The term “job” is intended to broadly mean an executable instance of an application, such as a Streams Processing Language application.

The terms “Streams Processing Language” and “SPL” are intended to broadly mean a programming language that specifies a set of operators and the communication connections (i.e. streams) between the operators. For example, IBM's Streams Processing Language may be used in connection with code for an application to execute on one of IBM's InfoSphere Streams products. An embodiment of this disclosure may, but is not limited to, use an application coded using an SPL.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope and spirit of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

What is claimed is:

1. A data stream controller information processing system comprising:
memory;
a stream history repository for storing one or more data stream history collected from at least inputs and outputs of a working stream computing environment (SCE);
a training model repository for storing at least one candidate training model of the SCE processing input data streams and output data streams;
an SCE simulator for off-line simulating the SCE processing according to one of the at least one candidate training model of the SCE processing input data streams and output data streams, based on one or more data streams history stored in the stream history repository;
an SCE I/O Analyzer for analyzing at least results of the off-line simulating the SCE processing input data streams and output data streams, based on one or more data streams history stored in the stream history repository; and
a processor communicatively coupled to the memory, the stream history repository, the training model repository, the SCE simulator, and the SCE I/O Analyzer, wherein the processor, responsive to executing computer instructions, performs operations comprising:
capturing one or more data streams history of at least inputs and outputs of a working SCE;
off-line simulating, with the processor, at least one candidate training model of the SCE processing input data streams and output data streams, according to the one or more data streams history;
varying modulation of the input data streams into the at least one candidate training model of the SCE during the off-line simulating;
analyzing effects of the varying modulation of the input data streams, during the off-line simulating of the SCE processing, on the output data streams; and
determining, based on the analyzing, effectiveness of each of the at least one candidate training model of the SCE to regulate input data streams without affecting, within acceptable tolerance limits, the SCE processing of the output data streams during the off-line simulating of the SCE processing.

2. The information processing system of claim 1, further comprising:
a working model repository for storing a working SCE model; and
an input stream regulator controller for controlling and regulating input data streams of the working SCE, based on the working SCE model stored in the working model repository; and
wherein the processor, responsive to executing the computer instructions, performs operations comprising:
selecting, based on the determining, one of the at least one candidate training model of the SCE; and
regulating input data streams of the working SCE based at least on a selected one candidate training model.

3. The information processing system of claim 2, wherein the processor, responsive to executing computer instructions, performs operations comprising:
based on the regulating of the input data streams of the working SCE, at least one of the following:
bandwidth usage at one or more inputs of the working SCE that receive regulated input data streams is reduced;
bandwidth requirements of one or more channels that communicate regulated input data streams to the working SCE are reduced;
data storage requirements of the working SCE are reduced;
computational load of the working SCE is reduced; and
energy usage of the working SCE is reduced.

4. The information processing system of claim 2, wherein based on the regulating of the input data streams of the working SCE, at least one of:
bandwidth usage at one or more inputs of the working SCE that receive regulated input data streams is reduced, and
computational load of the working SCE is reduced,
through selective down-sampling of input data streams of at least one of the one or more inputs of the working SCE.

5. The information processing system of claim 2, wherein based on the regulating of the input data streams of the working SCE, at least one of:
bandwidth usage at one or more inputs of the working SCE that receive regulated input data streams is reduced, and
computational load of the working SCE is reduced,
through selective elimination of at least one of the one or more inputs of the working SCE.

6. The information processing system of claim 2, wherein the regulating input data streams of the working SCE comprises at least one of:
selective elimination of at least one of the one or more inputs of the working SCE; and
selective down-sampling of input data streams of at least one of the one or more inputs of the working SCE.

7. A non-transitory computer readable storage medium, comprising computer instructions which, responsive to being executed by a processor, cause the processor to perform operations comprising:
capturing one or more data streams history of at least inputs and outputs of a working stream computing environment (SCE);
off-line simulating, with a processor of an information processing system, at least one candidate training model of the SCE processing input data streams and output data streams according to the one or more data streams history;
varying modulation of the input data streams into the at least one candidate training model of the SCE during the off-line simulating;
analyzing effects of varying modulation of the input data streams, during the off-line simulating of the SCE processing, on the output data streams; and
determining, based on the analyzing, effectiveness of each of the at least one candidate training model of the SCE to regulate input data streams without affecting, within acceptable tolerance limits, the SCE processing of the output data streams during the off-line simulating of the SCE processing.

8. The computer readable storage medium of claim 7, comprising computer instructions which, responsive to being executed by the processor, cause the processor to perform operations comprising:
selecting, based on the determining, one of the at least one candidate training model of the SCE; and
regulating input data streams of the working SCE based at least on the selected one candidate training model.

9. The computer readable storage medium of claim 8, comprising computer instructions which, responsive to being executed by the processor, cause the processor to perform operations comprising:
ranking each of the at least one candidate training model of the SCE based on a score assigned to each candidate, at least based on effectiveness of the each candidate to regulate input data streams without affecting, within acceptable tolerance limits, the SCE processing of the output data streams during the off-line simulating of the SCE processing.

10. The computer readable storage medium of claim 9, wherein the score assigned to the each candidate comprises a weighted sum score (WS) calculated for the each candidate, based on the off-line simulating of the SCE processing, as follows: WS=w1*S+w2*R, where
each of w1 and w2 is a weight value,
S=a merit score indicative of the effectiveness to regulate input data streams without affecting, within acceptable tolerance limits, the SCE processing of the output data streams, and
R=a merit score indicative of a reduction (or savings) in at least one, or a combination, of the following:
reduction in bandwidth usage at one or more inputs of the SCE that receive regulated input data streams,
reduction in bandwidth requirements of one or more channels that communicate regulated input data streams to the SCE,
reduction in data storage requirements of the SCE,
reduction in computational load of the SCE, and
reduction in energy usage of the SCE; and wherein
each weight value (w1 and w2) is within a range that indicates relative importance to the SCE processing under a particular context of operation of the SCE.

11. The computer readable storage medium of claim 9, wherein the selecting comprises:
analyzing and categorizing a particular context of operation of the SCE; and
selecting, based on the analyzing and categorizing and on the determining, one of the at least one candidate training model of the SCE.
